(19) United States
(12) Patent Application Publication
(10) Pub. No.: US 2014/0277959 A1
(43) Pub. Date: Sep. 18, 2014

(54) MULTI-SEED PLANTER CONTROL SYSTEM AND METHOD FOR THE SAME

(71) Applicants: Jesse L. Wagers, Sioux Falls, SD (US); Douglas Samuel Prairie, Sioux Falls, SD (US); Charlie R. Schoenfelder, Sioux Falls, SD (US); Raymond K. Munk, Sioux Falls, SD (US); Stephen Filip Fjelstad, Worthing, SD (US)

(72) Inventors: Jesse L. Wagers, Sioux Falls, SD (US); Douglas Samuel Prairie, Sioux Falls, SD (US); Charlie R. Schoenfelder, Sioux Falls, SD (US); Raymond K. Munk, Sioux Falls, SD (US); Stephen Filip Fjelstad, Worthing, SD (US)

(21) Appl. No.: 13/842,326

(22) Filed: Mar. 15, 2013

(51) Int. Cl. A01C 21/00; A01B 49/06; A01B 76/00

(52) U.S. Cl. CPC A01C 21/005; A01B 76/00; A01B 49/06
USPC 701/50

(57) ABSTRACT

A method of automatically planting two or more seed types with an agricultural planter includes monitoring a planter location on a prescription map of an agricultural field. The planter includes one or more remotely adjustable planting characteristics. A seed type is selected based on the monitored planter location on the prescription map, the seed type including two or more seed types. The selected seed type is dispensed to one or more seed metering systems of one or more row units based on the selected seed type. As the planter moves in the agricultural one or more of the remotely adjustable planting characteristics of the planter field is dynamically changed based on at least the seed type selected according to the monitored planter location.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc.; Sioux Falls, S. Dak. All Rights Reserved.

### TECHNICAL FIELD

This document pertains generally, but not by way of limitation, to agricultural planters and methods for using the same.

### BACKGROUND

Agricultural planters are used in farming to consolidate one or more functions of a planting process including digging a furrow, placement of seeds, application of agricultural products (e.g., fertilizer and the like) and closing of the seeded furrow. Planters generally include a seed bin (or bins) in communication with individual row units the each include coulters and seed metering systems. The individual row units dig a furrow, plant a dispensed seed type, optionally apply an agricultural product, and close the furrow.

In some examples, planters include two or more seed bins with each seed bin including a differing seed type, for instance differing hybrid varieties for a particular crop, such as corn or soy beans. In another example, planters include a bifurcated seed bin configured to hold differing seed types in different chambers of the seed bin. To switch between seed types the operator manually or electronically operates a valve or shutter that closes one of the seed bins (chambers) and opens another seed bin (or chamber).

In another example, a prescription map is used to map out a field and location signals are used to determine a seed type for the planter in combination with the prescription map.

### OVERVIEW

The present inventors have recognized, among other things, that a problem to be solved can include overcoming static or semi-static planting characteristics of a planter, such as vacuum level, population rate, coulter down pressure and the like that provides two or more differing seed types. Stated another way, gross selection of differing seed types (hybrids or entirely different crops) frustrates one or more planting characteristics of the planter when planting at least one of the differing seed types.

For instance, different hybrids of the same crop, such as corn or soy beans, have differing shapes, sizes, mass, growing characteristics and the like. Accordingly, there are optimum planting characteristics (vacuum level, population rate, coulter down pressure and the like) for each of the differing seeds. Planters with static or semi-static planting characteristics (e.g., adjustable with breaks in planting or with tools) that include a plurality of seed types are unable to dynamically adapt to the differing planting characteristics needed to optimally plant each of the seed types. For instance, the vacuum applied through a seed disk for a first seed type having a first shape and size is insufficient for a second larger seed type with a second shape and size. Similarly, different seed types also benefit from shallower or deeper planting. By providing a static down pressure a planter is unable to dynamically adjust to ideal planting depths for a plurality of seed types (and is unable to adjust for changing soil conditions, changing weight of the planter as seed is dispensed or the like).

In an example, the present subject matter can provide a solution to this problem, such as by a method of automatic planting of two or more seed types with a planter. The method monitors a planter location on a prescription map of a field, selects a seed type based on the monitored planter location on the prescription map, and then dynamically changes one or more of the planter characteristics based on at least the selected seed type. For instance, one or more of vacuum level, population rate, coulter down pressure and the like are dynamically adjusted as the planter moves through a field according to the selected seed type and the monitored location of the planter on the prescription map. Dynamic changing of the planter characteristics ensures that each of a variety of seed types are handled and planted according to the characteristics of the seed (and optionally other characteristics of the field or prescription map). Some of the planter characteristics that are dynamically changed during operation of the planter include, but are not limited to, vacuum level, population rate, coulter down pressure, agricultural product selection and application rate or the like. Optionally, planter characteristics are changed by selection of one of two or more sets of row units, where each of the sets of row units are configured for optimal planting of a seed type (e.g., one type of hybrid).

In another example, the present subject matter provides a method of automatic planting that dynamically changes one or more remotely adjustable planting characteristics of each row unit of a plurality of row units on the planter. For example, the method selects a first seed type for a first set of row units (one or more of a plurality of row units) based on the planter location on the prescription map, including the location of the first set of row units. The method selects a second seed type for a second set of row units (one or more of the plurality of row units) based on a differing planter location of the second set of row units on the prescription map. The remotely adjustable planting characteristics are separately and dynamically adjusted for each of the two sets of row units according to the varying selected seed types.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of one example of a tractor and multi-seed planter.

FIG. 2 is a schematic diagram of one example of a section of a multi-seed planter including at least two sets of row units.

FIG. 3 is a top view of one example of a prescription map for an agricultural field.

FIG. 4 is a schematic diagram showing one example of a control system for a multi-seed planter.

FIG. 5A is a schematic diagram showing one example of a control loop for seed selection.

FIG. 5B is a schematic diagram showing one example of a control loop for vacuum level in a row unit.

FIG. 5C is a schematic diagram showing one example of a control loop for population rate in a row unit.

FIG. 5D is a schematic diagram showing one example of a control loop for coulter down pressure in a row unit.

FIG. 5E is a schematic diagram showing one example of a control loop for agricultural product selection and application in a row unit.

FIG. 6 is a block diagram showing one example of a method for automatically planting two or more seed types with an agricultural planter.

FIG. 7 is a schematic diagram showing another example of a control system for a multi-seed planter.

FIG. 8 is a schematic diagram showing a tractor and multi-seed planter indexed on a prescription map corresponding to an agricultural field and transitioning between zones having differing planter characteristics.

FIG. 9 is a block diagram showing one method of remotely changing an adjustable planting characteristic including changing between sets of row units corresponding to two or more seed types.

### DETAILED DESCRIPTION

FIG. 1 shows one example of an implement train 100 including for instance a leading vehicle 102, such as a tractor and a multi-seed planter 104. In one example the implement train 100, for instance each of the leading vehicle 102 and the multi-seed planter 104, include position sensing instrumentation (e.g., GPS instrumentation), such as respective GPS antennas 103, 105, associated with each of the vehicles of the implement train 100. As will be described herein in one example the GPS antennas 103, 105 are used to determine the location of the implement train 100, (e.g., the positions of the leading vehicle 102 and the multi-seed planter 104) to accordingly control a type of seed dispensed and one or more adjustable planting characteristics of the planter for each of one or more row units 114 as the plurality of row units are located within one or more zones, for instance zones on a prescription map corresponding to an agricultural field the implement train 100 is currently operating within.

Referring again to FIG. 1, the multi-seed planter 104 as shown includes a plurality of features configured to plant differing varieties of a seed or differing seeds. For instance the multi-seed planter 104 includes a seed hopper 108. In the example shown in FIG. 1 the seed hopper 108 includes first and second hoppers 110, 112. As will be described herein in one example the first and second hoppers 110, 112 contain corresponding varieties of different hybrids of the same seed, for instance different hybrids of corn, soybeans, wheat or the like. In another example, the first and second hoppers 110, 112 include differing seeds, for instance the first hopper 110 includes corn and the second hopper 112 includes soybeans.

In the example shown in FIG. 1 each of the seed hoppers 108 is associated with one of a plurality of row units 114. In one example each of the row units 114 are separately controllable for instance by a control system as described herein. In another example sections of row units 114 are each controllable relative to other sections of row units. In still another example the plurality of row units 114 are operable as a unit and are accordingly operated in cooperation with one another. That is to say, each of the row units 114 operates to dispense the same seed according to the same prescription as described herein. As shown in FIG. 1 each of the row units 114 are positioned along corresponding booms 106 of the multi-seed planter 104.

In another example, the multi-seed planter 104 includes one or more agricultural product reservoirs 116, 118. For instance, in one example a liquid fertilizer or herbicide is provided in the agricultural product reservoir 116. In one example the agricultural product reservoir 116 is distributed throughout the row units 114 for instance to corresponding spray units associated with each of the one or more row units 114 or associated with two or more row units 114. In another example the multi-seed planter 104 includes other agricultural product reservoirs 118 for instance granular insecticide reservoirs associated with each of the row units 114. The agricultural product reservoirs 118 are configured to provide the agricultural product contemporaneously with dispensing and planting of seeds. As will be described herein the multi-seed planter 104, for instance a control system associated with the multi-seed planter 104 is configured to select one of a plurality of seed types for instance provided within the seed hopper 108 and accordingly dispense the seed from one or more of the row units 114 according to the position of the multi-seed planter 104 within an agricultural field, for instance an agricultural field with indexed zones having prescriptions for particular seed types and planter characteristics. Additionally, the multi-seed planter 104, for instance a control system associated with the multi-seed planter is configured to vary one or more planter characteristics of the multi-seed planter 104 according to the selected seed type, the corresponding location of the planter 104 (or the locations of one or more of the row units 114) on a field corresponding to a prescription map. The control system for the multi-seed planter 104 accordingly varies one or more planter characteristics (e.g., coulter down pressure, vacuum level for a seed wheel, type and rates of agricultural product dispensing and the like) according to the seed type and the location of the planter 104 (e.g., locations of one or more of the row units 114) to thereby optimally plant and husband the seeds according to a prescription provided by a prescription map associated with the control system.

Referring now to FIG. 2 another example of a multi-seed planter 200 is provided. In this example a section of the multi-seed planter 200 is shown in detail. For instance the multi-seed planter 200 includes first and second sets of row units 202, 204. As shown the first and second sets of row units 202, 204 are separated by way of dashed lines to accordingly show the different arrays of the row units relative to each set. As further shown in FIG. 2 the first and second sets of row units 202, 204 (each of the individual row units associated with the sets) is spaced apart according to a row unit set lateral offset 206 (lateral offset herein). In one example, each of the first and second sets of row units 202, 204 includes separate components for each of the respective row units (e.g., coulters, seed metering systems including seed wheels, seed hoppers and the like). Accordingly in one example the first set of row units 202 includes a first type of seed such as a first hybrid of a particular seed and the second set of row units 204 includes a second type of seed such as a second hybrid of the same seed. In another example the first and second sets of row units 202, 204 contain differing seeds therein for instance the first set of row units 202 includes corn while the second set of row units 204 includes wheat, soybeans or the like.

FIG. 3 shows one example of a prescription map 300. As shown the prescription map 300 corresponds to an agricultural field with a plurality of prescription zones overlaid over top of the field. In the view to the right of the overall prescription map 300 a zoomed in portion of the prescription map is provided. The portion of the zoomed in prescription map 300 includes a plurality of zones 302. Each of the zones 302 in one example includes a corresponding seed type associated with each of the zones (e.g., a prescription for the respective zone).

As will be described herein as the multi-seed planter (e.g., 104 or 200) is moved through each of the zones 302 a location positioning system such as a GPS antenna 105 associated with the multi-seed planter 104 indexes the location of the planter within the prescription map 300 and accordingly keys the planter 104 to the particular zone 302 it is moving through. Accordingly the multi-seed planter 104 for instance a control system associated with the multi-seed planter selects a particular seed type according to the prescription provided in the zones 302. In one example each of the row units 114 within the particular zone such as the zones 302 dispenses the seed type selected according to the prescription provided for that respective zone. In one example the seed type associated with each of the zones 302 is selected to provide the optimum yield for the respective zones. That is to say the prescription map 300 is in one example written to accordingly index one or more seeds to respective zones and cooperate with the control system to dispense the indexed seeds in the corresponding zones 302 based on the relevant terrain, moisture content, nutritional content of the soil, prior experience with the zones and other factors that assist in selecting the seed type.

As further shown in FIG. 3, the first and second zones 304, 306 are provided as demonstrative examples. As previously described the plurality of zones 302 include prescriptions for seed selection for each of the respective zones 302. Additionally in other examples the zones 302 (as shown with the demonstrative first and second zones 304, 306) include additional prescription characteristics to further enhance the characteristics of the planter to optimally plant a seed (e.g., with one or more agricultural products, at a particular planting depth, according to an optimal population rate and the like). For instance as shown in FIG. 3 the first and second zones 304, 306 include a plurality of characteristics determined by one or more of the seed type, the terrain type or the like for the prescription map 300. For instance in the first zone 304 the seeds type, population rate and terrain type is specified. For instance as shown in FIG. 3 the first zone 304 has a seed type (ST₁), a specified population rate (PR₁) and a specified terrain type (TT₁). In one example, each of these characteristics are specified for the particular zone 304 according to the optimum seed type for that zone as well as the terrain characteristics and the desired population rate (with one or more of the characteristics optionally chosen or weighted according to the seed type selected). In a similar manner the second zone 306 has its own respective characteristics for instance seed type, population rate and terrain type (ST₂, PR₂ and TT₂). Each of the zones 302, for instance of the entire prescription map 300, are mapped with one or more characteristics corresponding to at least seed type and optionally one or more other characteristics, such as terrain type or population rate. Each of these one or more indexed values are used by the control system to select a seed type and dynamically adjust one or more planter characteristics to provide optimal planting of the selected seed type.

In one example, the seed type prescribed in each of the zones 302 correspondingly determines one or more planter characteristics of the multi-hybrid planter 104 including for instance one or more remotely adjustable planting characteristics of one or more of the row units 114 previously shown in FIG. 1 including, but not limited to, population rate of the selected seed type, planter vacuum level for a seed disk, row unit down-pressure of one or more of the row unit coulters, and the selection of one or more agricultural products and the rate of application of the one or more agricultural products. In one example the selection of seed type for each of the row units 114 accordingly dictates (based on a seed type database contained within the control system of the planter 104) one or more of these characteristics of the planter 104. Accordingly the planter 104 is controlled at one or more of the row units (e.g., a plurality of the row units or each of the row units are separately controlled) to accordingly plant the seed according to the specified characteristics and vary the characteristics between each of the row units, a subset of the row units or across all of the row units.

In another example where each of the zones 302 for instance the first and second zones 304, 306 include other characteristics such as population rate, terrain type and the like each of these characteristics optionally adjusts or tunes the corresponding planter characteristics previously determined for the seed type. That is to say, the selection of the seed type provides an initial configuration of remotely adjustable planting characteristics and the addition of other characteristics for each of the zones, such as the first and second zones 304, 306, tunes the particular planting characteristics within that zone according to, for instance, the population rate and the terrain type indexed to each of the particular zones.

FIG. 4 shows one example of a multi-seed control system 400 for instance a control system 400 for use with a multi-seed planter 104 shown in FIG. 1. In describing the multi-see control system 400 a plurality of modules are shown to illustrate the control functions and interrelations of the components (e.g., of the planter) and functions of each of the modules. Each of the modules described herein may be implemented with machines or computer-implemented at least in part. Some examples can include a computer-readable medium or machine-readable medium encoded with instructions operable to configure an electronic device to perform methods as described in the above examples. Further, the modules and their functions are, in an example, tangibly stored on one or more volatile, non-transitory, or non-volatile tangible computer-readable media, such as during execution or at other times.

As shown in FIG. 4 the multi-seed control system 400 includes a controller 402 coupled with one or more of the row units 114 previously shown in FIG. 1. The controller 402 is associated with the multi-seed planter 104 or is housed within a field computer for instance the field computer associated with the leading vehicle 102. As shown each of the row units 114 include a plurality of features or mechanisms associated with each of the row units. For instance, the seed metering system 120 of the exemplary row unit 114 includes in one example one or more of a a seed disk 412 and a motor, such as a hydraulic motor associated with the seed disk 412. In one example, the controller 402 provides instructions to each of the features of the row unit 114 for instance including the features of the seed metering system 120 as well as other features such as the coulter (corresponding to a coulter down-pressure) and one or more agricultural product dispensers such as a sprayer or a pneumatic dispenser 418. In one example the controller 402 communicates with the row unit 114 by way of an electronic control unit 420 associated with the individual row unit. The optional electronic control unit 420 receives control signals from the controller 402, interprets them and accordingly provides separate control signals (e.g., instructions) to each of the components of the row unit 114 (e.g., components 410-418).

As further shown in FIG. 4 a plurality of inputs 401 feed into the controller 402. In one example the inputs fed into the controller 402 include but are not limited to the location of the planter 104 (e.g., determined with a GPS antenna 105 associated with the planter 104), information regarding the prescription map such as that provided by a prescription map module (a storage device including a prescription map module therein) 404 and a seed database 406. As shown in FIG. 4 in one example the seed database 406 includes a library of information, for instance information regarding one or more seeds and in other examples hybrids of a particular type of seed. As shown in the example of FIG. 4, in one example the seed database 406 includes information on each of two hybrid types of corn including information corresponding to the hybrids such as specified vacuum level, down-pressure, population rate and agricultural product prescriptions according to the hybrid type. In a similar example, characteristics regarding another type of seed, such as soybeans are also provided. In one example the seed database 406 accordingly associates one or more planter characteristics such as seed disk vacuum level, coulter down-pressure, population rate (corresponding to operation of hydraulic motor configured to rotate the seed disk) and agricultural product dispensation with each of the types of seeds.

In another example the controller 402 is optionally coupled with one or more sensors associated with the planter 104 or the leading vehicle 102 including for instance terrain characteristic sensors. In one example the terrain characteristics 408 fed to the controller 402 include one or more of accelerometer information corresponding to the roughness of the terrain, moisture content within the soil, grade measurements and the like.

As will be described herein the controller 402 receives the inputs 401. In one example the location of the planter 104 for instance determined with the GPS antenna 105 cooperates with the prescription map module 404 to accordingly determine a seed type to be dispensed by one or more of the row units 114. As further shown in FIG. 4 in one example the seed type selected by way of cooperation between the GPS antenna 105 and the prescription map module 404 corresponds to a seed type contained within the seed database 406. Accordingly, the seed database when associated with a particular seed type selected by way of the GPS antenna and the prescription map module provides one or more planter characteristics to the controller 402. The controller 402 accordingly sends instructions to one or more of the row units 114 corresponding to the seed type selected for the particular zone of the field including one or more row units 114. If one or more of the row units within a corresponding zone is designated for a first hybrid of corn the controller 402 accordingly remotely controls the plurality of adjustable planting characteristics of each of the one or more respective row units 114.

For instance, the controller 402 based on the seed type selected and the according prescription for each of the seeds adjusts one or more characteristics of the one or more row units 114. In one example a seed selector 410 is operated to accordingly feed the selected seed to the seed metering system 120 (e.g., including the seed disk driven by a motor such as a hydraulic motor, the vacuum fan). The seed disk 412 accordingly adjusts its vacuum level according to the seed type selected based on instructions from the controller 402. The vacuum level is adjusted in one example to reliably hold each of the seeds along the seed disk (e.g, based on the respective size, shape, and weight of the seed) for planting according to a population rate for instance a population rate determined by a rotational speed provided by the motor 416. In another example the population rate controlled by the motor 416 is also determined by the controller 402 by way of the prescription provided in the seed database 406. In still another example, the controller 402 controls a down-pressure of the coulter 414 according to the seed type being planted. The coulter pressure is in one example adjusted upwardly or downwardly to provide a desired depth for planting of the selected seed. In a similar manner one or more of the sprayer or pneumatic dispenser 418 for liquid and granular agricultural products 418 are adjusted to provide a desired type and amount of the respective agricultural product based on the seed selected and optionally one or more of the terrain characteristics for instance provided by the terrain characteristic module 408 corresponding to one or more sensors or terrain characteristics associated with the plurality of zones (e.g., the zones 302) in the prescription map 300.

Accordingly with multi-seed control system 400 provided in FIG. 4 one or more of the characteristics of the planter for instance a plurality of remotely adjustable planting characteristics are adjusted for one or more of the row units 114 according to the seed type selected and optionally according to one or more other characteristics, for instance terrain characteristics and the like. The multi-seed control system 400 is thereby able to optimally plant a plurality of seed types for instance one or more hybrids within the same field according to information indexed to the zones 302 of the prescription map 300 3. The prescription map 300 provides indicates the seed type to be planted in each of one or more zones and accordingly the seed type (optionally in combination with one or more characteristics) is used to adjust one or more of the planting characteristics of one or more of the row units 114 to achieve optimal planting of each of the seed types.

FIGS. 5A-E show a plurality of exemplary systems associated with each of the one or more row units 114 for instance the row units associated with either of the multi-seed planters 104, 200. Referring first to FIG. 5A one example of a seed selector 410, for instance a control loop for a seed selector 410 is provided. As shown a seed selection input 500 for instance provided by the controller 402 shown in FIG. 4 (based on the prescription map module 404 as well as the location of the planter determined with the GPS antenna 105) is input to the valve controller 502. Based on the instruction received (the seed selection input 500) the valve controller 502 provides one of two control signals 504, 506 to the selector valve 508. As shown in FIG. 5A, in one example the valve controller 502 is configured to provide a first control signal (e.g., a first valve signal 504) corresponding to a first seed type, for instance a first hybrid. Additionally the valve controller 502 is configured to provide a second control signal (e.g., a second valve signal 506) corresponding to a second seed type such as a second hybrid. The selector valve 508 accordingly operates for instance by rotation of the valve to open one or more of the seed hoppers such as the first and second seed hoppers 110, 112 shown in FIG. 1.

In one example a valve position sensor 510 is coupled with the selector valve 508. The valve position sensor in one example includes an encoder or other sensor configured to determine and confirm the position of the selector valve 508. As shown in FIG. 5A, in one example the valve position sensor 510 cooperates in a feedback control loop with the valve controller 502 to accordingly ensure each of the valve signals 504, 506 is accurately opening or closing the selector valve 508. In another example the valve position sensor 510 provides rate information to the valve controller 502. For instance the selector valve 508 is configured to provide a varying flow rate of seeds into the row unit 114. Accordingly the selector valve 508 is openable to varying degrees for each of the seed types for instance the seed types contained within each of the first and second hoppers 110, 112, and according to the desired rate of.

Referring now to FIG. 5B one example of the seed disk 412 (of the seed metering system 120 of an exemplary row unit 114) for instance the vacuum control loop of the seed disk 412 is provided. As shown in the example a vacuum level input 511 is received from the controller 402 and is input to the vacuum controller 512 (e.g., based on the location of the row unit and relevant prescription at the zone). The vacuum controller 512 accordingly adjusts a valve, such as a pulse width modulation valve 513 to adjust the rotational speed of a vacuum fan 514. In one example the pulse width modulation valve 513 controls a flow of hydraulic fluid to a hydraulic motor associated with the vacuum fan 514. Accordingly a vacuum is drawn for the seed disk.

In another example an air pressure sensor 516 is provided adjacent to the seed disk. The air pressure sensor 516 communicates with the valve controller 512 and in one example provides a closed feedback loop to allow for continued adjustment of the vacuum fan speed to achieve the desired vacuum level 511 at the seed disk 412, for instance corresponding to the selected seed type (e.g., based on seed weight, shape, size and the like).

FIG. 5C shows one example of a seed disk 416 for instance a seed disk motor controller 520 for use with the seed disk of a seed metering system 120. The controller 520 adjusts the population rate of a seed for instance a seed selected by way of the controller 402 (e.g., in cooperation with a prescription map module 404, seed database 406 and the like). As shown in FIG. 5C a population rate input 518 corresponding for instance to a seed disk motor speed is input to the seed disk motor controller 520. The seed disk motor controller 520 actuates a control valve 522 to accordingly adjust the speed of a seed meter 524 (e.g., a motor). In one example the seed meter 524 includes a motor, such as a hydraulic motor coupled with the seed disk. In another example the seed meter 524 includes but is not limited to a transmission coupled with the seed disk for instance a chain transmission, gear transmission or the like taken off of a main shaft of the planter 104.

In one example an encoder 526 is associated with the seed meter 524. The encoder 526 optionally communicates with the seed disk motor controller 520 to provide feedback control of the population rate for instance by continued adjustment of the control valve 522 to achieve a desired seed disk motor speed corresponding to the specified population rate (e.g., the population rate input).

FIG. 5D shows one example of a coulter 414, for instance the control lop associated with the coulter 414, associated with one of the row units 114 of the multi-seed planter 104. As shown in FIG. 5D, a down-pressure input 528 is provided to a fluid controller 530. In one example the down-pressure is provided by a controller 402 based on the position of the planter 104 and the corresponding prescription for a seed type provided by the prescription map module 404 (e.g., provided in one example with the seed database 406). In one example the fluid controller 530 actuates a pulse width modulation valve 532 to accordingly operate a hydraulic or pneumatic cylinder 536 (for instance by the provision of hydraulic fluid, air or the like to the hydraulic or pneumatic cylinder 536).

Optionally a pressure transducer 534 is provided on one side of the pulse width modulation valve 532 and cooperates with the fluid controller 530 to accordingly ensure a proper amount of hydraulic or pneumatic flow is provided to the hydraulic or pneumatic cylinder 536. Additionally in another example a load cell 538 is coupled with the output of the hydraulic pneumatic cylinder 536 to accordingly measure a down force provided by the hydraulic or pneumatic cylinder 536 to the coulter 414. As shown in FIG. 5D the output of the load cell 538 is communicated to the fluid controller 530 to accordingly provide additional control of the fluid controller 530 and the pulse width modulation valve 532 to achieve the desired down-pressure as provided by the controller 402.

Referring now to FIG. 5E one example of an agricultural product dispenser 418 such as one or more of a sprayer or pneumatic system for respective liquid or granular fertilizer, herbicide, insecticide or the like is provided. In the control loop shown in FIG. 5E an agricultural product input 540 is provided to the valve controller 542. In one example the agricultural product input 540 includes but is not limited to a type of agricultural product as well as a rate of dispensing of the agricultural product provided by the controller 402 and based upon the location of the planter (or the respective row unit 114) within a zone of the prescription map (e.g., within the prescription map module 404). For instance in one example the agricultural product input 540 includes two or more agricultural products and varying rates of application of each of the two or more agricultural products. The valve controller 542 communicates with at least one control valve 544 based on the agricultural product input 540. For instance the control valve 544 is opened or closed to adjust a rate of dispensation of the respective agricultural product (whether liquid, granular or the like). In one example a rate sensor 546 is provided on the output side of the control valve 544 to accordingly measure the opening of the control valve 544 and the actual dispensation rate (e.g., as a flow meter) from the agricultural product dispenser 418. The output from the rate sensor 546 is communicated to the valve controller 542 to achieve a desired target rate and type of agricultural product dispensation by feedback control. Optionally, each of one or more agricultural product dispensers (at either of the reservoirs 116, 118 or at the dispensing devices such as spouts, nozzles or sprayers) includes an agricultural product control loop of the type or similar to that shown in FIG. 5E.

As further shown in FIG. 5E, in one example a shutoff valve 548 is associated with the agricultural product dispenser 418. In one example the valve controller 542 further operates the shutoff valve 548 to accordingly shut off the flow of one or more of liquid or granular agricultural product to the respective row unit 114. Accordingly in one example the control valve 544 is used to apply a particular rate of an agricultural product with the respective row unit 114 while the shutoff valve 548 is used to toggle between application or an interruption of application of the agricultural product at the rate provided by the control valve 544.

FIG. 6 shows one example of a method 600 for automatically planting two or more seed types with an agricultural planter such as the planter 104 previously shown in FIG. 1. In describing the method 600 reference is made to one or more components, features, functions and steps described herein. For convenience, reference is made to the components, features, steps and the like with reference numerals. Reference numerals provided are exemplary and are not exclusive. For instance, features, components, functions, steps and the like described in the method 600 include but are not limited to the corresponding numbered elements provided herein. Other corresponding features described herein (both numbered and unnumbered) as well as their equivalents are also considered.

At 602, the method 600 includes monitoring a planter location for instance the location of the planter 104 (and optionally each or one or more of the row units 114) by way of one or more GPS antennas 105. In one example as shown in FIG. 1 a GPS antenna 105 is associated with a central portion of the planter 104. In another example one or more of the row units, for instance each of the row units 114 includes its own position sensor such as a GPS position sensor. The planter location 104 is monitored on a prescription map, such as the prescription map 300 shown in FIG. 3 of an agricultural field. The planter 104 includes one or more remotely adjustable planting characteristics, for instance the characteristics shown and described herein including, but not limited to, seed selection, vacuum level, coulter down-pressure, population rate, agricultural product type and rate and the like.

At 604, the method 600 further includes selecting a seed type for instance one or more differing types of seeds or one or more hybrid types of the same type of seed based on the monitored planter location on the prescription map 300. As described herein the seed types include one or more hybrids of the same type of seed or differing seeds for instance provided in one or more hoppers such as the first and second hoppers 110, 112 shown in FIG. 1. At 606, the selected seed type is dispensed to one or more seed metering systems such as the seed metering systems 120 shown in FIG. 4 and further shown in its component parts in at least some of FIGS. 5A-E. The seed type is selected by way of the controller 402 cooperating with the prescription map module 404 as shown in FIG. 4. The seed type is dispensed to each of the one or more seed metering systems 120 associated with respective row units 114. As described herein in one example the planter 104 moves through a plurality of zones, as one or more of the row units 114 moves through one or more zones the controller 402 is configured by way of position sensing of the planter 104 generally or each of the row units 114 to accordingly select a seed type and input the seed type to the corresponding row units 114 in each of the prescription map zones.

At 608, as the planter 104 moves in the agricultural field the method 600 dynamically changes one or more of the remotely adjustable planting characteristics of the planter 104 (for instance of one or more of the corresponding row units 114 within one or more zones of the prescription map) based on at least the seed type selected based on the monitored planter (or row unit) location.

Several options for the method 600 follow. In one example dynamically changing one or more remotely adjustable planting characteristics includes individually dynamically changing one or more planter characteristics for one or more row units 114 of a plurality of row units such as the row units 114 shown for the planter 104 in FIG. 1. The one or more planter characteristics of each of the row units is dynamically changed according to the row unit location of each of the row units on the prescription map 300. For instance where one or a subset of the row units 114 are positioned within a first zone the one or more corresponding planter characteristics for those row units 114 are accordingly adjusted or controlled by the controller 402 according to the zone within which the row units are positioned. Similarly the remaining row units 114 of the planter 104 within for instance a second zone, such as the zone 306 shown in FIG. 3, are controlled according to different parameters for instance corresponding to the seed type and optionally the population rate and terrain type specified for the second zone 306.

In another example dynamically changing one or more of the remotely adjustable planting characteristics includes dynamically changing one or more remotely adjustable planting characteristics based on at least the selected seed type for instance corresponding to one or more of the zones of the prescription map 404 and the monitored planter location on the prescription map. For instance as previously described herein where one or more of the zones such as the zones 304, 306 include for instance population rate, terrain characteristics and the like in another example these characteristics indexed to each of the zones are further used to additionally tune or change the plurality of remotely adjustable planting characteristics of the planter 104 (for instance one or more of the row units 114).

In another example the method 600 includes dynamically changing one or more of the remotely adjustable planting characteristics including the characteristics of one or more seed metering systems 120 of a corresponding number of row units 114 of the plurality of row units 114. For instance in one example the controller controls the seed selection 410 of one or more hoppers such as the first and second hoppers 110, 112 (based on the prescription map module, sensed position or the like). As further described herein the controller 402 for instance in cooperation with the prescription map module 404 and the GPS antenna 105 is further configured to control one or more characteristics of the row units including, but not limited to, vacuum level applied to the seed disk 412, coulter 414 down-pressure, a population rate corresponding for instance to the rotational speed of the seed disk 412 and the motor 416 and one or more dispensing rates or types of agricultural product dispensed.

In one example dynamically changing one or more remotely adjustable planting characteristics further includes controlling a population rate of one or more seed metering systems 120 based on the selected seed type and the monitored planter location. For instance in one example one or more of the seed types has a population rate optimal for the particular seed type. Accordingly in one example the motor 416 (or seed meter) is rotated at a particular speed to accordingly provide a population rate or rate of seed dispensing from the seed metering system 120 for planting. In another example controlling the population rate of the one or more seed metering systems 120 for instance of a corresponding number of row units 114 includes controlling the population rate based on the prescription map 300 for instance one or more location based population rates for instance associated with one or more of the zones 302 for instance one of the first and second zones 304, 306.

In another example dynamically changing one or more remotely adjustable planting characteristics includes controlling a planter vacuum level for instance of the seed disk 412. Accordingly the retention force of the selected seed type provided by the controller 402 is adjusted for one or more of the seed metering systems 120 associated with respective row units 114 for instance as shown in FIG. 4. In one example specified vacuum levels are associated with each of one or more hybrids or each of a differing seed types and the controller 402 changes the vacuum level for instance of one or more of the seed disks 412 is based on the selected seed type.

In another example dynamically changing one of the remotely adjustable planting characteristics includes controlling a row unit down-pressure of one or more of the row unit coulters 414. In one example the row unit down-pressure is adjusted based on the selected seed type (to accordingly provide a desired planting depth) and the planter location on the prescription map 404 for instance determined with the GPS antenna 105 (or antennas associated with one or more of the row units 114). Optionally control of the row unit down-pressure further includes controlling the row unit down pressure of one or more row unit coulters 414 of a plurality of row unit coulters (e.g., of one or more of the row units 114) according to row unit locations of the one or more row units or a plurality of the overall row units of the planter 104 within the prescription map 300. That is to say with one or more of the row units 114 within a first zone the controller 402 accordingly provides instructions to those corresponding coulters 414 to accordingly provide a desired down-pressure corresponding to the selected seed type.

In still another example dynamically changing one or more of the remotely adjustable planting characteristics further includes selecting an agricultural product (e.g., one or more of a liquid or granular product) for application according to one or more of the selected seed type or the monitored planter location 104 on the prescription map 300. Optionally changing one or more remotely adjustable planting characteristics optionally includes controlling an application rate of the agricultural product selected according to one or more of the selected seed type or the monitored planter location on the prescription map. In still another example one or more of the selection or control of the application rate of the agricultural product is determined according to the position of one or more of the plurality of row units 114 within one or more of the zones of the prescription map 300.

Optionally monitoring the planter location on the prescription map 300 includes continuously updating at least the planter location with a navigation system, for instance by way of a GPS antenna 105 or other positioning system such as localized positioning systems provided near the agricultural field. Additionally dynamically changing one or more of the remotely adjustable planting characteristics is continuously conducted based on at least the continuously updated planter location and the corresponding indexed seed of the prescription map. For instance as the planter location is updated with the planter moving through a field and from zone to zone the multi-seed control system 400 shown in FIG. 4 continuously updates the position of the planter 104 and accordingly adjusts the dynamic characteristics of one or more of the row units 114 within corresponding zones based on the selected seed type and other characteristics associated with the particular zone.

FIG. 7 shows another example of a multi-seed control system 700. In the example shown in FIG. 7 the control system 700 is configured to operate a multi-seed planter 200 such as that shown in FIG. 2. Referring again to FIG. 2 the multi-seed planter 200 includes first and second sets of row units 202, 204. The first and second sets of row units 202, 204 include separate row units 114 laterally offset with respect to row units 114 of the adjacent set by a lateral offset 206. That is to say, in one example the first set of row units 202 includes a first seed type while a second set of row units 204 includes a second seed type. Optionally each of the first and second sets of row units 202, 204 are configured for a particular type of seed and for instance include one or more planting characteristics specified for optimal planting of each of the respective seed types. Engagement of each of the first and second sets of row units 202, 204 corresponds to remote adjustment of the planting characteristics of the planter. That is to say by selective engagement of the first or second sets of row units 202, 204 according to the selected seed type for instance by way of the prescription map module 404 described herein the multi-seed planter 200 including the first and second sets of row units 202, 204 is able to dynamically change one or more remotely adjustable planting characteristics by selection of either of the first or second sets of row units.

Referring again to FIG. 7 as shown the multi-seed control system 700 includes a controller 702. In one example the controller 702 is associated with the multi-seed planter 200 or is housed within a field computer for instance the field computer associated with the leading vehicle 102. In describing the multi-seed control system 700 a plurality of modules are shown to illustrate the control functions and interrelations of the components (e.g., of the planter) and functions of each of the modules. Each of the modules described herein may be implemented with machines or computer-implemented at least in part. Some examples can include a computer-readable medium or machine-readable medium encoded with instructions operable to configure an electronic device to perform methods as described in the above examples. Further, the modules and their functions are, in an example, tangibly stored on one or more volatile, non-transitory, or non-volatile tangible computer-readable media, such as during execution or at other times.

As shown in FIG. 7 the controller 702 is configured to receive one or more inputs 701. In at least some regards the multi-seed control system 700 provides similar inputs to the inputs for the multi-seed control system 400 previously described herein. For instance the prescription map module 404 stores at least one prescription map, such as the map 300 shown in FIG. 3 and the seed database 406 correspondingly provides one or more planting characteristics for one or more of the systems of the multi-seed planter 200 for instance one or more seed metering systems 120 or one or more characteristics of the respective first and second sets of row units 202, 214.

In another example one of the inputs 701 optionally includes terrain characteristics fed to the controller 702. In one example the terrain characteristics 408 are determined with one or more sensors provided on the planter 200 or optionally provided with a leading vehicle 102. The terrain characteristics 408 include but are not limited to the moisture content of the soil, accelerometer data corresponding to the roughness of the terrain, the grade of the terrain and the like.

As further shown in FIG. 7 the inputs 701 of the multi-seed control system 700 further include GPS location data. The GPS location data includes for instance the location provided by a GPS antenna 105 of the planter 200. In another example additional GPS information for instance the position of the leading vehicle 102, one or more row units 114 or the like are also provided to the controller 702. In one example the position information of the leading vehicle 102 is used in cooperation with a shifting module 704 to accordingly maintain a continuous planting line between the first and second sets of row units 202, 204 for instance as the planter 200 is transitioning between first and second zones provided by a prescription map such as the prescription map 300.

Referring again to FIG. 7 the planter 200 in one example includes a row unit engagement module 710. In one example the seed selection provided by the controller 702 for instance through cooperation between the prescription map module 404 and one or more of the GPS antennas 103, 105 is used to select a seed type. As shown for instance in FIG. 2 the seed types are associated with one of the first and second sets of row units 202, 204. Accordingly, based on selected seed type the row unit engagement module 710 is configured to bring on line one of the first and second sets of row units 202, 204 as the planter 200 enters into the corresponding zone with that indexed seed type.

In another example, the controller 702 includes a shifting module 704. The shifting module 704 is configured to communicate with the leading vehicle 102 for instance an output device 706 such as a monitor or aural device or an automated steering system 708. In one example the shifting module 704 provides an instruction to either of the output device 706 or the automated steering device 708 to accordingly shift the leading vehicle 102 and move the row units of either of the first or second sets of row units 202, 204 (whichever is schedule to be engaged for in the next zone) at the interface between the first and second zones. That is to say, the shifting module 704 provides an instruction (an instruction to the automated steering system 708 or an alert to the output device 706) that accordingly allows the leading vehicle 102 to shift to the left or right and accordingly maintain a continuous planting line between each of the row units of the respective first and second sets of row units 202, 204.

Referring now to FIG. 8 an implement train such as the implement train 801 is shown including the leading vehicle 102 coupled with the multi-seed planter 200. As shown the implement train 801 is moving between first and second zones where the first and second zones each have differing seed types indexed to the respective zones. In an example, the second seed type is associated with the second set of row units 204 for instance in zone 1 and the first seed type is associated with a first set of row units 202 in zone 2. As shown in FIG. 8 at the zone interface 800 the second and first sets of row units 202, 204 are respectively disengaged and engaged to accordingly transition from the second seed type to the first seed type.

In one example the multi-seed planter 200 requires at least some interval of time to transition between the first and second sets of row units 202, 204 (e.g., 15 second, 30 seconds or the like based on the configuration and actuation of the row unit sets). To maintain a continuous planting line without gaps, for instance across the zone interface 800, it is desirable to accordingly bring the first set of row units 202 on line immediately at the zone interface 800 and correspondingly deactivate the second set of row units 204. Accordingly in one example the forward observation module 706 (see FIG. 7) is provided for instance in the multi-seed control system 700 to initiate transition from the second set of row units 204 to the first set of row units 202 prior to the zone interface 800. In one example the forward observation module 706 cooperates with one or more of the GPS antennas 103, 105 and the prescription map module 404 to note the distance of the implement train 801 from the zone interface 800. The forward observation module 706 notes a location some distance away from the zone interface 800 corresponding to an initiation location 802 to begin engagement of the first set of row units 202 (e.g., with the row unit engagement module 710 of the multi-seed control system 700). In one example the row unit engagement module 710 includes one or more systems of the multi-seed planter 200 configured to transition operation between the first and second sets of row units 202, 204. As the implement train 801 approaches the initiation location 802 for instance as the GPS antenna 105 of the multi-seed planter 200 arrives at the initiation location 802 the row unit engagement module 710 begins the transition from the second set of row units 204 to the first set of row units 202. Optionally instead of setting an initiation location the forward observation module begins a clock for instance based on the rate of approach of the implement train 801 to the zone interface 800 and the transition interval required by the planter 200 to switch between row unit sets. At the expiration of the clock initiation of the change between the first and second sets of row units 202, 204 is initiated by the row unit engagement module 710.

Accordingly with the transition begun at the initiation location 802 the row unit engagement module 710, at the zone interface 800 corresponding to a conclusion location 804 of the second row unit engagement, completes the transition to the first set of row units 202 and immediately at the zone interface 800 the first set of row units 202 begins planting operations with the first seed type (and operation of the second set of row units 204 is discontinued). Stated another way the multi-seed control system 700 for instance with the forward observation module 706 is accordingly able to initiate row unit engagement (e.g., with the row unit engagement module 710 shown in FIG. 7) prior to reaching the zone interface 800. Accordingly as the implement train 801 transitions between each of the zones of a field mapped to a prescription map the multi-seed planter 200 is able to seamlessly change over between the first and second sets of row units 202, 204 to accordingly maintain continuous planting across all of the zones.

In another example and as shown again in FIG. 8, the implement train 801 is configured to shift according to the change between the first and second sets of row units 202, 204. As previously described, the controller 702 includes a shifting module 704 in communication with the leading vehicle 102. As one or more of the leading vehicle 102 or the multi-seed planter crosses the zone interface 800 the leading vehicle 102 shifts according to the row unit lateral offset 206 (shown in FIG. 2 and shown again in FIG. 8). That is to say the leading vehicle 102 shifts over and accordingly shifts the multi-seed planter 200 laterally to account for the offset 206 between the first and second sets of row units 202, 204. By shifting the multi-seed planter 200 as shown in FIG. 8 the first and second sets of row units 202, 204 provide a continuous planting line 806 across each of the first and second sets of row units and crossing the zone interface 800. Shifting of at least the multi-seed planter 200 (or its row units) accordingly maintains a continuous planting line 806 for each of the row units even as the multi-seed planter 200 transitions from first to second zones and accordingly changes seed types based on the engagement of either of the first or second sets of row units 202, 204.

As shown in the example of FIG. 8 shifting between the first and second sets of row units 202, 204 is optionally conducted by way of lateral movement of the leading vehicle 102. In another example, shifting of the first and second sets of row units 202, 204 is accomplished with one or more other mechanisms provided on the multi-seed planter 200 or with the leading vehicle 102. For instance, a component of the leading vehicle 102 coupled with the leading vehicle hitch is laterally shifted to accordingly shift the planter 200. In still another example, a component of the planter, for instance a common interface between each of the first and second sets of row units is laterally shifted to accordingly shift the sets of row units 202, 204 (relative to the remainder of the planter 200) and maintain the continuous planting line 806. In still another example, prior to shifting the disengaging set of row units 202, 204 is raised from the ground. As the planter (or the sets of row units) is shifted the ground is accordingly not disturbed by laterally moving coulters of the row units, and the engaging set of row units 204, 202 is then engaged with the ground to maintain the continuous planting line. In each of these examples, the shifting module 704 of the controller 702 operates the corresponding mechanism to provide the desired shift.

Optionally, shifting of the planter or one or more of the sets of row units 202, 204 is not required. For instance, the respective row units of each of the sets 202, 204 are aligned. In this arrangement, the disengaging set of row units 202, 204 is raised prior to (or at the same time) that the engaging set of row units 204, 202 is lowered. Accordingly, only a single set of row units is deployed to the ground at any one time to limit wear of the row units and also minimize soil disturbance (and disturbance to newly planted seeds). Optionally, the down force hydraulic or pneumatic cylinder 536 (e.g., associated with the coulter 414) or packing pressure hydraulic cylinder is operated to selectively raise or lower either of the first or second sets of row units 202, 204 while the other set of row units 204 is static or oppositely deployed (lowered or raised).

FIG. 9 shows one example of a method 900 for automatically planting two or more seed types with an agricultural planter, such as the multi-seed planter 200 having first and second sets of row units 202, 204 as shown in FIG. 2. In describing the method 900 reference is made to one or more components, features, functions and steps described herein. Where convenient, reference is made to the components, features, functions, steps and the like with reference numerals. Reference numerals provided are exemplary and are not exclusive. For instance features, components, functions, steps and the like described in the method 900 include, but are not limited to, the corresponding numbered elements provided herein. Other corresponding features described herein (both numbered and unnumbered) as well as their equivalents are also considered.

At 902, the method 900 includes changing from a first set of row units 202 to a second set of row units 204 of the planter 200 based on at least a selected seed type for instance a seed type indexed to one or more zones of a prescription map such as the prescription map 300 shown in FIG. 3. The first set of row units 202 are configured to plant a first seed type and the second set of row units 204 are configured to plant a second seed type where the first and second seed types are different. As previously described herein the first and second sets of row units are spaced from one another according to a lateral offset 206.

At 904 the method 900 includes shifting one or more of the first or second row units laterally according to the lateral offset 206 upon changing from the first set of row units 202 to the second set of row units 204 (or conversely from the second set of row units 204 to the first set of row units 202). At 906, the method further includes maintaining linear planting lines for instance the continuous planting line 806 shown in the example of FIG. 8 between the first and second set of row units 202, 204 with the shifting (e.g., of the leading vehicle 102, some portion of the leading vehicle such as the hitch, the planter 200, or some portion of the planter such as one or more of the sets of row units 202, 204). For instance with instructions from the controller 702 the row unit engagement module 710 transitions the planter 200 from one of the first or second set of row units 202, 204 to the other of the first or second sets of row units. The shifting described above and herein is monitored by the controller, for instance by way of the GPS antennas 103, 105 to ensure a continuous planting line (e.g., the line 806 shown in FIG. 8) is maintained between transitions of the row units 202, 204. The controller 702 (in cooperation with the shifting module 704) in one example shifts one or more of the leading vehicle 102 or the planter 200 according to the lateral offset 206 to maintain the continuous line 806.

Optionally in one example maintaining the linear planting lines includes automatically shifting the leading vehicle for instance with an automated steering system 708 associated with the leading vehicle 102 and optionally controlled with the controller 702 by way of a shifting module 704. As described above, the leading vehicle is laterally shifted through steering in one example (for instance by aural alerts delivered to the operator or operation of an automated steering system 708). Optionally, a portion of the leading vehicle, for instance at the hitch or part of the hitch, is shifted to accordingly shift the planter 200. In another example, a portion of the planter (e.g., carrying both of the first and second sets of row units) laterally shifts the sets of row units. As further described herein, shifting is optional, for instance with first and second sets of row units having aligned row units. In this arrangement the disengaging set of row units 202, 204 is optionally raised prior to (or at the same time) that the engaging set of row units 204, 202 is lowered. Accordingly, only a single set of row units is deployed to the ground at any one time to limit wear of the row units and also minimize soil disturbance (and disturbance to newly planted seeds). In another example the method 900 further includes initiating the change between the first and second row units 202, 204 prior to arrival at a monitored planter location corresponding to the second seed type. For instance as shown in FIG. 8 in one example initiation of the change between the first and second row units is initiated at the initiation location 802 determined with forward observation module 706 cooperating with one or more of the GPS antennas 103, 105 as well as the prescription map module 404 (having a zone interface 800 indicated there). Accordingly the change to the second set of row units (or optionally the first set of row units from the second set of row units) is completed upon arrival at the monitored planter location for instance the zone interface 800 between first and second zones.

In still another example, the disengaging set of row units 202, 204 is raised prior to shifting of one or more of the sets of row units. In another example, the engaging set of row units is not engaged with the ground until after shifting. Accordingly, as the planter (or the sets of row units) is shifted the ground is accordingly not disturbed by laterally moving coulters of the row units, and the engaging set of row units 204, 202 is then engaged with the ground to maintain the continuous planting line.

### VARIOUS NOTES & EXAMPLES

Example 1 can include subject matter such as a method of automatically planting two or more seed types with an agricultural planter comprising: monitoring a planter location on a prescription map of an agricultural field, the planter including one or more remotely adjustable planting characteristics; selecting a seed type based on the monitored planter location on the prescription map, the seed type including two or more seed types; dispensing the selected seed type to one or more seed metering systems of one or more row units based on the selected seed type; and as the planter moves in the agricultural field dynamically changing one or more of the remotely adjustable planting characteristics of the planter based on at least the seed type selected according to the monitored planter location.

Example 2 can include, or can optionally be combined with the subject matter of Example 1, to optionally include wherein dynamically changing one or more remotely adjustable planting characteristics includes individually dynamically changing one or more planter characteristics for one or more row units of a plurality of row units according to row unit locations of the one or more row units on the prescription map.

Example 3 can include, or can optionally be combined with the subject matter of one or any combination of Examples 1 or 2 to optionally include wherein dynamically changing one or more remotely adjustable planting characteristics of the planter includes dynamically changing one or more remotely adjustable planting characteristics based on at least the selected seed type and the monitored planter location on the prescription map.

Example 4 can include, or can optionally be combined with the subject matter of one or any combination of Examples 1 through 3 to optionally include wherein dynamically changing one or more of the remotely adjustable planting characteristics includes dynamically changing one or more remotely adjustable planting characteristics of one or more seed metering systems of corresponding row units of a plurality of row units.

Example 5 can include, or can optionally be combined with the subject matter of one or any combination of Examples 1-4 to optionally include wherein dynamically changing one or more remotely adjustable planting characteristics includes controlling a population rate of the one or more seed metering systems based on the selected seed type and the monitored planter location.

Example 6 can include, or can optionally be combined with the subject matter of Examples 1-5 to optionally include wherein controlling the population rate of the one or more seed metering systems includes controlling the population rate based on the prescription map including one or more location-based population rates.

Example 7 can include, or can optionally be combined with the subject matter of Examples 1-6 to optionally include wherein controlling the population rate of the one or more seed metering systems includes individually controlling the population rate of the one or more seed metering systems of the corresponding row units according to row unit locations of each of the corresponding row units on the prescription map.

Example 8 can include, or can optionally be combined with the subject matter of Examples 1-7 to optionally include wherein dynamically changing one or more remotely adjustable planting characteristics includes controlling a planter vacuum level and corresponding retention force of the selected seed type along respective seed disks of the one or more seed metering systems based on the selected seed type.

Example 9 can include, or can optionally be combined with the subject matter of Examples 1-8 to optionally include wherein dynamically changing one or more remotely adjustable planting characteristics includes controlling a row unit down pressure of one or more row unit coulters based on the selected seed type and the planter location on the prescription map.

Example 10 can include, or can optionally be combined with the subject matter of Examples 1-9 to optionally include wherein controlling the row unit down pressure of one or more row unit coulters includes individually controlling the row unit down pressure of one or more row unit coulters of a plurality of row unit coulters according to row unit locations of the one or more row units of a plurality of row units on the prescription map.

Example 11 can include, or can optionally be combined with the subject matter of Examples 1-10 to optionally include wherein dynamically changing one or more remotely adjustable planting characteristics includes one or more of: selecting an agricultural product for application according to one or more of the selected seed type or the monitored planter location on the prescription map, or controlling an application rate of the agricultural product according to one or more of the selected seed type or the monitored planter location on the prescription map.

Example 12 can include, or can optionally be combined with the subject matter of Examples 1-11 to optionally include wherein one or more of selecting the agricultural product or controlling the application rate of the agricultural product includes one or more of selecting the agricultural product or controlling the application rate of the agricultural product for the one or more row units of a plurality of row units according to row unit locations of the one or more row units on the prescription map.

Example 13 can include, or can optionally be combined with the subject matter of Examples 1-12 to optionally include wherein monitoring the planter location on the prescription map includes continuously updating the planter location with a navigation system, and dynamically changing one or more of the remotely adjustable planting characteristics of the planter is continuously conducted based on at least the selected seed type and the continuously updated planter location.

Example 14 can include, or can optionally be combined with the subject matter of Examples 1-13 to optionally include wherein dynamically changing one or more of the remotely adjustable planting characteristics includes: changing from a first set of row units to a second set of row units of the planter based on at least the selected seed type, the first set of row units configured to plant a first seed type and the second set of row units is configured to plant a second seed type, wherein the first and second sets of row units are spaced from one another by a lateral offset.

Example 15 can include, or can optionally be combined with the subject matter of Examples 1-14 to optionally include wherein changing from the first set of row units to the second set of row units includes: initiating the change prior to arrival at a monitored planter location corresponding to the second seed type, and completing the change to the second set of row units upon arrival of the planter at the monitored planter location corresponding to the second seed type.

Example 16 can include, or can optionally be combined with the subject matter of Examples 1-15 to optionally include wherein dynamically changing one or more of the remotely adjustable planting characteristics includes: shifting one or more of the first or second sets of row units laterally according to the lateral offset with changing from the first set of row units to the second set of row units, and maintaining linear planting lines between the first and second sets of row units with the shifting.

Example 17 can include, or can optionally be combined with the subject matter of Examples 1-16 to optionally include wherein shifting one or more of the first or second sets of row units includes automatically shifting a leading vehicle according to changing from the first set of row units to the second set of row units.

Example 18 can include, or can optionally be combined with the subject matter of Examples 1-17 to optionally include wherein dynamically changing one or more of the remotely adjustable planting characteristics includes: changing from a first set of row units to a second set of row units of the planter based on at least the selected seed type, the first set of row units configured to plant a first seed type and the second set of row units is configured to plant a second seed type, raising the first set of row units from the ground, and lowering the second set of row units to the ground, wherein one of the first or second sets of row units is in the ground at any time while planting.

Example 19 can include, or can optionally be combined with the subject matter of Examples 1-18 to optionally include wherein dynamically changing one or more of the remotely adjustable planting characteristics includes laterally shifting at least one of the first or second sets of row units to maintain linear planting lines between the first and second sets or row units, and laterally shifting is between raising and lowering.

Example 20 can include, or can optionally be combined with the subject matter of Examples 1-19 to optionally include wherein dynamically changing one or more of the remotely adjustable planting characteristics includes: raising the first set of row units from the ground, each of the row units of the first set of row units are positioned along linear planting lines, and lowering the second set of row units to the ground, each of the row units of the second set of row units are positioned along the linear planting lines, where the row units of the first set of row units are aligned with respective row units of the second set of row units.

Example 21 can include, or can optionally be combined with the subject matter of Examples 1-20 to optionally include a processor-readable medium comprising instructions that, when executed by a processor circuit, cause the processor circuit to: monitor a planter location on a prescription map of an agricultural field, the planter including one or more remotely adjustable planting characteristics; select a seed type based on the monitored planter location on the prescription map, the seed types including two or more seed types; dispense the selected seed type to one or more seed metering systems of one or more row units based on the selected seed type; and as the planter moves in the agricultural field dynamically change one or more of the remotely adjustable planting characteristics of the planter based on at least the selected seed type according to the monitored planter location.

Example 22 can include, or can optionally be combined with the subject matter of Examples 1-21 to optionally include wherein dynamic change of one or more remotely adjustable planting characteristics includes individual dynamic change of one or more planter characteristics for one or more row units of a plurality of row units according to row unit locations of the one or more row units on the prescription map.

Example 23 can include, or can optionally be combined with the subject matter of Examples 1-22 to optionally include wherein dynamic change of one or more remotely adjustable planting characteristics of the planter includes dynamic change of one or more remotely adjustable planting characteristics based on at least the selected seed type and the monitored planter location on the prescription map.

Example 24 can include, or can optionally be combined with the subject matter of Examples 1-23 to optionally include wherein dynamic change of one or more of the remotely adjustable planting characteristics includes dynamic change of one or more remotely adjustable planting characteristics of one or more seed metering systems of corresponding row units of a plurality of row units.

Example 25 can include, or can optionally be combined with the subject matter of Examples 1-24 to optionally include wherein dynamic change of one or more remotely adjustable planting characteristics includes control of a planter vacuum level and corresponding retention force of the selected seed type along respective seed disks of the one or more seed metering systems based on the selected seed type.

Example 26 can include, or can optionally be combined with the subject matter of Examples 1-25 to optionally include wherein dynamic change of one or more remotely adjustable planting characteristics includes control of a row unit down pressure of one or more row unit coulters based on the selected seed type and the planter location on the prescription map.

Example 27 can include, or can optionally be combined with the subject matter of Examples 1-26 to optionally include wherein dynamic change of one or more remotely adjustable planting characteristics includes one or more of: selection of an agricultural product for application according to one or more of the selected seed type or the monitored planter location on the prescription map, or control of an application rate of the agricultural product according to one or more of the selected seed type or the monitored planter location on the prescription map.

Example 28 can include, or can optionally be combined with the subject matter of Examples 1-27 to optionally include wherein monitoring the planter location on the prescription map includes continuously updating the planter location with a navigation system, and dynamic change of one or more of the remotely adjustable planting characteristics of the planter is continuously conducted based on at least the selected seed type and the continuously updated planter location.

Example 29 can include, or can optionally be combined with the subject matter of Examples 1-28 to optionally include wherein dynamic change of one or more of the remotely adjustable planting characteristics includes: change from a first set of row units to a second set of row units of the planter based on at least the selected seed type, the first set of row units configured to plant a first seed type and the second set of row units is configured to plant a second seed type, wherein the first and second sets of row units are spaced from one another by a lateral offset.

Example 30 can include, or can optionally be combined with the subject matter of Examples 1-29 to optionally include wherein dynamic change of one or more of the remotely adjustable planting characteristics includes: shifting one or more of the first or second sets of row units laterally according to the lateral offset with changing from the first set of row units to the second set of row units, and maintaining linear planting lines between the first and second sets of row units with the shifting.

Example 31 can include, or can optionally be combined with the subject matter of Examples 1-30 to optionally include wherein shifting one or more of the first or second sets of row units includes automatically shifting a leading vehicle according to change from the first set of row units to the second set of row units.

Example 32 can include, or can optionally be combined with the subject matter of Examples 1-31 to optionally include wherein dynamic change of one or more of the remotely adjustable planting characteristics includes: change from a first set of row units to a second set of row units of the planter based on at least the selected seed type, the first set of row units configured to plant a first seed type and the second set of row units is configured to plant a second seed type, raising of the first set of row units from the ground, and lowering of the second set of row units to the ground, wherein one of the first or second sets of row units is in the ground at any time while planting.

Example 33 can include, or can optionally be combined with the subject matter of Examples 1-32 to optionally include wherein dynamic change of one or more of the remotely adjustable planting characteristics includes laterally shifting of at least one of the first or second sets of row units to maintain linear planting lines between the first and second sets or row units, and laterally shifting is between raising and lowering.

Example 34 can include, or can optionally be combined with the subject matter of Examples 1-33 to optionally include a multi-seed planter control system comprising: a prescription map module including a prescription map of an agricultural field; a location monitoring module configured to monitor a planter location on the prescription map; a seed selection module configured to control the supply of each of two or more seed types to one or more seed metering systems of one or more row units; and a controller in communication with each of the prescription map module, the location monitoring module and the seed selection module, the controller configured to: select a seed type of the two or more seed types according to a monitored planter location on the prescription map, and as the planter moves in the agricultural field dynamically change one or more remotely adjustable planting characteristics based on the seed type selected according to the monitored planter location.

Example 35 can include, or can optionally be combined with the subject matter of Examples 1-34 to optionally include wherein the prescription map module includes a seed type prescription map having a plurality of indexed locations distributed over the seed type prescription map, each of the indexed locations corresponding to one seed type of two or more seed types.

Example 36 can include, or can optionally be combined with the subject matter of Examples 1-35 to optionally include wherein the prescription map module includes a prescription map having one or more indexed locations distributed over prescription map, each of the indexed locations corresponding to one or more of a terrain type or a population rate for a seed type.

Example 37 can include, or can optionally be combined with the subject matter of Examples 1-36 to optionally include wherein the seed selection module is configured for coupling with a valve that selectively opens and closes the supplies of each of the two or more seed types, and the valve is operable according to the seed type selection of the controller.

Example 38 can include, or can optionally be combined with the subject matter of Examples 1-37 to optionally include a row unit engagement module in communication with the controller, the row unit engagement module configured to control engagement of one or more sets of row units according to the seed type selected by the controller, each of the one or more sets of row units configured to plant a differing seed type.

Example 39 can include, or can optionally be combined with the subject matter of Examples 1-38 to optionally include a forward observation module in communication with the row unit engagement module, the prescription map module and the location monitoring module, the forward observation module configured to: initiate operation of the row unit engagement module prior to arrival at a monitored planter location corresponding to a first seed type, and complete operation of the row unit engagement module upon arrival at the monitored planter location corresponding to a first seed type.

Example 40 can include, or can optionally be combined with the subject matter of Examples 1-39 to optionally include wherein the controller includes a leading vehicle shifting module in communication with a leading vehicle, the leading vehicle shifting module configured to: shift the leading vehicle according to a lateral offset between the one or more sets of row units with changing of engagement of one set of row units to another set of row units of the one or more sets of row units, and maintain linear planting lines between engagement of the one or more sets of row units through shifting of the leading vehicle according to the lateral offset.

Example 41 can include, or can optionally be combined with the subject matter of Examples 1-40 to optionally include a population rate module in communication with the controller, the population rate module configured to control the population rate of one or more row units according to the seed type selected by the controller.

Example 42 can include, or can optionally be combined with the subject matter of Examples 1-41 to optionally include a vacuum level module in communication with the controller, the vacuum level module configured to control the vacuum level of one or more row units corresponding to a retention force of the selected seed type along respective seed disks of one or more seed metering systems of one or more row units according to the seed type selected by the controller.

Example 43 can include, or can optionally be combined with the subject matter of Examples 1-42 to optionally include a coulter down pressure module in communication with the controller, the coulter down pressure module configured to control the down pressure of one or more coulters of one or more respective row units according to one or more of the seed type selected by the controller and the monitored planter location.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method of automatically planting two or more seed types with an agricultural planter comprising:
monitoring a planter location on a prescription map of an agricultural field, the planter including one or more remotely adjustable planting characteristics;
selecting a seed type based on the monitored planter location on the prescription map, the seed type including two or more seed types;
dispensing the selected seed type to one or more seed metering systems of one or more row units based on the selected seed type; and
as the planter moves in the agricultural field dynamically changing one or more of the remotely adjustable planting characteristics of the planter based on at least the seed type selected according to the monitored planter location.

2. The method of claim 1, wherein dynamically changing one or more remotely adjustable planting characteristics includes individually dynamically changing one or more planter characteristics for one or more row units of a plurality of row units according to row unit locations of the one or more row units on the prescription map.

3. The method of claim 1, wherein dynamically changing one or more remotely adjustable planting characteristics of the planter includes dynamically changing one or more remotely adjustable planting characteristics based on at least the selected seed type and the monitored planter location on the prescription map.

4. The method of claim 1, wherein dynamically changing one or more of the remotely adjustable planting characteristics includes dynamically changing one or more remotely adjustable planting characteristics of one or more seed metering systems of corresponding row units of a plurality of row units.

5. The method of claim 4, wherein dynamically changing one or more remotely adjustable planting characteristics includes controlling a population rate of the one or more seed metering systems based on the selected seed type and the monitored planter location.

6. The method of claim 5, wherein controlling the population rate of the one or more seed metering systems includes controlling the population rate based on the prescription map including one or more location-based population rates.

7. The method of claim 5, wherein controlling the population rate of the one or more seed metering systems includes individually controlling the population rate of the one or more seed metering systems of the corresponding row units according to row unit locations of each of the corresponding row units on the prescription map.

8. The method of claim 4, wherein dynamically changing one or more remotely adjustable planting characteristics includes controlling a planter vacuum level and corresponding retention force of the selected seed type along respective seed disks of the one or more seed metering systems based on the selected seed type.

9. The method of claim 1, wherein dynamically changing one or more remotely adjustable planting characteristics includes controlling a row unit down pressure of one or more row unit coulters based on the selected seed type and the planter location on the prescription map.

10. The method of claim 9, wherein controlling the row unit down pressure of one or more row unit coulters includes individually controlling the row unit down pressure of one or more row unit coulters of a plurality of row unit coulters according to row unit locations of the one or more row units of a plurality of row units on the prescription map.

11. The method of claim 1, wherein dynamically changing one or more remotely adjustable planting characteristics includes one or more of:
selecting an agricultural product for application according to one or more of the selected seed type or the monitored planter location on the prescription map, or
controlling an application rate of the agricultural product according to one or more of the selected seed type or the monitored planter location on the prescription map.

12. The method of claim 11, wherein one or more of selecting the agricultural product or controlling the application rate of the agricultural product includes one or more of selecting the agricultural product or controlling the application rate of the agricultural product for the one or more row units of a plurality of row units according to row unit locations of the one or more row units on the prescription map.

13. The method of claim 1, wherein monitoring the planter location on the prescription map includes continuously updating the planter location with a navigation system, and
dynamically changing one or more of the remotely adjustable planting characteristics of the planter is continuously conducted based on at least the selected seed type and the continuously updated planter location.

14. The method of claim 1, wherein dynamically changing one or more of the remotely adjustable planting characteristics includes:
changing from a first set of row units to a second set of row units of the planter based on at least the selected seed type, the first set of row units configured to plant a first seed type and the second set of row units is configured to plant a second seed type, wherein the first and second sets of row units are spaced from one another by a lateral offset.

15. The method of claim 14, wherein changing from the first set of row units to the second set of row units includes:
initiating the change prior to arrival at a monitored planter location corresponding to the second seed type, and
completing the change to the second set of row units upon arrival of the planter at the monitored planter location corresponding to the second seed type.

16. The method of claim 14, wherein dynamically changing one or more of the remotely adjustable planting characteristics includes:
shifting one or more of the first or second sets of row units laterally according to the lateral offset with changing from the first set of row units to the second set of row units, and
maintaining linear planting lines between the first and second sets of row units with the shifting.

17. The method of claim 16, wherein shifting one or more of the first or second sets of row units includes automatically shifting a leading vehicle according to changing from the first set of row units to the second set of row units.

18. The method of claim 1, wherein dynamically changing one or more of the remotely adjustable planting characteristics includes:
changing from a first set of row units to a second set of row units of the planter based on at least the selected seed type, the first set of row units configured to plant a first seed type and the second set of row units is configured to plant a second seed type,
raising the first set of row units from the ground, and
lowering the second set of row units to the ground, wherein one of the first or second sets of row units is in the ground at any time while planting.

19. The method of claim 18, wherein dynamically changing one or more of the remotely adjustable planting characteristics includes laterally shifting at least one of the first or second sets of row units to maintain linear planting lines between the first and second sets or row units, and laterally shifting is between raising and lowering.

20. The method of claim 18, wherein dynamically changing one or more of the remotely adjustable planting characteristics includes:
raising the first set of row units from the ground, each of the row units of the first set of row units are positioned along linear planting lines, and
lowering the second set of row units to the ground, each of the row units of the second set of row units are positioned along the linear planting lines, where the row units of the first set of row units are aligned with respective row units of the second set of row units.

21. A processor-readable medium comprising instructions that, when executed by a processor circuit, cause the processor circuit to:
monitor a planter location on a prescription map of an agricultural field, the planter including one or more remotely adjustable planting characteristics;
select a seed type based on the monitored planter location on the prescription map, the seed types including two or more seed types;
dispense the selected seed type to one or more seed metering systems of one or more row units based on the selected seed type; and
as the planter moves in the agricultural field dynamically change one or more of the remotely adjustable planting characteristics of the planter based on at least the selected seed type according to the monitored planter location.

22. The processor-readable medium of claim 21, wherein dynamic change of one or more remotely adjustable planting characteristics includes individual dynamic change of one or more planter characteristics for one or more row units of a plurality of row units according to row unit locations of the one or more row units on the prescription map.

23. The processor-readable medium of claim 21, wherein dynamic change of one or more remotely adjustable planting characteristics of the planter includes dynamic change of one or more remotely adjustable planting characteristics based on at least the selected seed type and the monitored planter location on the prescription map.

24. The processor-readable medium of claim 21, wherein dynamic change of one or more of the remotely adjustable planting characteristics includes dynamic change of one or more remotely adjustable planting characteristics of one or more seed metering systems of corresponding row units of a plurality of row units.

25. The processor-readable medium of claim 24, wherein dynamic change of one or more remotely adjustable planting characteristics includes control of a planter vacuum level and corresponding retention force of the selected seed type along respective seed disks of the one or more seed metering systems based on the selected seed type.

26. The processor-readable medium of claim 24, wherein dynamic change of one or more remotely adjustable planting characteristics includes control of a row unit down pressure of one or more row unit coulters based on the selected seed type and the planter location on the prescription map.

27. The processor-readable medium of claim 21, wherein dynamic change of one or more remotely adjustable planting characteristics includes one or more of:
selection of an agricultural product for application according to one or more of the selected seed type or the monitored planter location on the prescription map, or
control of an application rate of the agricultural product according to one or more of the selected seed type or the monitored planter location on the prescription map.

28. The processor-readable medium of claim 21, wherein monitoring the planter location on the prescription map includes continuously updating the planter location with a navigation system, and
dynamic change of one or more of the remotely adjustable planting characteristics of the planter is continuously conducted based on at least the selected seed type and the continuously updated planter location.

29. The processor-readable medium of claim 21, wherein dynamic change of one or more of the remotely adjustable planting characteristics includes:
change from a first set of row units to a second set of row units of the planter based on at least the selected seed type, the first set of row units configured to plant a first seed type and the second set of row units is configured to plant a second seed type, wherein the first and second sets of row units are spaced from one another by a lateral offset.

30. The processor-readable medium of claim 29, wherein dynamic change of one or more of the remotely adjustable planting characteristics includes:
shifting one or more of the first or second sets of row units laterally according to the lateral offset with changing from the first set of row units to the second set of row units, and
maintaining linear planting lines between the first and second sets of row units with the shifting.

31. The processor-readable medium of claim 30, wherein shifting one or more of the first or second sets of row units includes automatically shifting a leading vehicle according to change from the first set of row units to the second set of row units.

32. The processor-readable medium of claim 21, wherein dynamic change of one or more of the remotely adjustable planting characteristics includes:
change from a first set of row units to a second set of row units of the planter based on at least the selected seed type, the first set of row units configured to plant a first seed type and the second set of row units is configured to plant a second seed type,
raising of the first set of row units from the ground, and
lowering of the second set of row units to the ground, wherein one of the first or second sets of row units is in the ground at any time while planting.

33. The processor-readable medium of claim 32, wherein dynamic change of one or more of the remotely adjustable planting characteristics includes laterally shifting of at least one of the first or second sets of row units to maintain linear planting lines between the first and second sets or row units, and laterally shifting is between raising and lowering.

34. A multi-seed planter control system comprising:
a prescription map module including a prescription map of an agricultural field;
a location monitoring module configured to monitor a planter location on the prescription map;
a seed selection module configured to control the supply of each of two or more seed types to one or more seed metering systems of one or more row units; and
a controller in communication with each of the prescription map module, the location monitoring module and the seed selection module, the controller configured to:
select a seed type of the two or more seed types according to a monitored planter location on the prescription map, and
as the planter moves in the agricultural field dynamically change one or more remotely adjustable planting characteristics based on the seed type selected according to the monitored planter location.

35. The multi-seed planter control system of claim 34, wherein the prescription map module includes a seed type prescription map having a plurality of indexed locations distributed over the seed type prescription map, each of the indexed locations corresponding to one seed type of two or more seed types.

36. The multi-seed planter control system of claim 34, wherein the prescription map module includes a prescription map having one or more indexed locations distributed over prescription map, each of the indexed locations corresponding to one or more of a terrain type or a population rate for a seed type.

37. The multi-seed planter control system of claim 34, wherein the seed selection module is configured for coupling with a valve that selectively opens and closes the supplies of each of the two or more seed types, and the valve is operable according to the seed type selection of the controller.

38. The multi-seed planter control system of claim 34 comprising a row unit engagement module in communication with the controller, the row unit engagement module configured to control engagement of one or more sets of row units according to the seed type selected by the controller, each of the one or more sets of row units configured to plant a differing seed type.

39. The multi-seed planter control system of claim 38 comprising a forward observation module in communication with the row unit engagement module, the prescription map module and the location monitoring module, the forward observation module configured to:
initiate operation of the row unit engagement module prior to arrival at a monitored planter location corresponding to a first seed type, and
complete operation of the row unit engagement module upon arrival at the monitored planter location corresponding to a first seed type.

40. The multi-seed planter control system of claim 38, wherein the controller includes a leading vehicle shifting module in communication with a leading vehicle, the leading vehicle shifting module configured to:
shift the leading vehicle according to a lateral offset between the one or more sets of row units with changing of engagement of one set of row units to another set of row units of the one or more sets of row units, and
maintain linear planting lines between engagement of the one or more sets of row units through shifting of the leading vehicle according to the lateral offset.

41. The multi-seed planter control system of claim 34 comprising a population rate module in communication with the controller, the population rate module configured to control the population rate of one or more row units according to the seed type selected by the controller.

42. The multi-seed planter control system of claim 34 comprising a vacuum level module in communication with the controller, the vacuum level module configured to control the vacuum level of one or more row units corresponding to a retention force of the selected seed type along respective seed disks of one or more seed metering systems of one or more row units according to the seed type selected by the controller.

43. The multi-seed planter control system of claim 34 comprising a coulter down pressure module in communication with the controller, the coulter down pressure module configured to control the down pressure of one or more coulters of one or more respective row units according to one or more of the seed type selected by the controller and the monitored planter location.
